(19) United States
(12) Patent Application Publication
(10) Pub. No.: US 2004/0207738 A1
(43) Pub. Date: Oct. 21, 2004

(54) Digital photography method and digital camera

(76) Inventor: Alain Wacker, Flurlingen (CH)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/821,792

(22) Filed: Mar. 30, 2001

(51) Int. Cl. H04N 5/335; H04N 5/225

(52) U.S. Cl. 348/294

(57) ABSTRACT

The sensor matrix (1) is mechanically shifted by a preset vector (\overline{S}) to remove sensor-resistant impurities relative to their reproducing effect in digital photography. From the comparison of image storage (data) before and after the mechanical shift (7₁, 7₂, 9) and from the thereby resulting comparison signal matrix (Δ) it can be detected where sensor-fast impurities are present since through the mechanical shift there is also the image of the imaging beam (B₁, B₂) shifted but not the image of the impurities (x_{z}, y_{z}).

The present invention relates to a digital photography method according to the introductory clause of claim 1 and to a digital camera according to the introductory clause of claim 10.

Digital photography offers, on one hand, many advantages since no films have to be used and thereby running expenses are avoided. On the other hand, digital photography has nevertheless a considerable disadvantage: Blemishes in photo-chemical films appear only once—a new negative is used in fact for the subsequent image. In contrast, the same sensors are used for each image recording in the use of optoelectric sensors or transducers in digital photography. Blemishes from or on the image sensor occur over and over again.

As of this date, there are various method known to detect blemishes on an electrically recorded image and to eliminate or partially compensate for them by calculation. For example, to homogenize the varying quality of pixels, one may refer to the “blemish files” having information about faulty single pixels or row of pixels whose information must be interpolated from the neighboring pixels, and one may refer to the so-called “gain files/white shading method” having amplifying correction values for all pixels.

The present invention is based primarily on the object to detect blemishes in a simple and dependable manner, which are mechanically attached to the matrix of optoelectronic sensors, as for example, scratches on the sensor coating, dust particles on the matrix, faulty pixels or sensors and/or glass defects, scratches, dust etc. in or on the protective glass and/or the IR-blocking filter etc. disposed in front of the sensor and being attached thereto, for example, and to establish thereby the basis for a corresponding image correction.

During finding of the following illustrated inventive solution, it became apparent at the same time that detection of additional image criteria are made possible along with the found solution principle together with corresponding image finishing based on the detection.

In the digital photography method of the type specified in the beginning, the achievement of the mentioned object, primarily the mentioned blemish detection and additionally the opening of further detection possibilities of image characteristics, is made possible in that signals depending on the image signals of both images are forwarded to a comparison operation and an image of the comparison result is in turn produced in the form of electric comparison-result signals together with the respective sensor position information, whereby the first and/or the second recorded image is modified by means of electric signals of the comparison-result image.

Basically there is taken advantage of the fact that the mentioned blemishes or impurities (defects), which are mechanically attached to the matrix of optoelectric sensor elements and which shift together with the matrix during the shift of the matrix while the image impressed on the imaging beam shifts inversely to the matrix shift relative to the matrix. Should the matrix be shifted only to the right, for example, then the image of the image beam shifts to the left relative to the matrix. Since the image of the impurity remains stationary on the matrix, and the image in the imaging beam shifts on the matrix, the latter (image) shifts relative to the impurity image.

It is the basis for the present invention to recognize this different behavior as a simple discrimination criteria. This relates to digital monochrome photography as well as to digital color photography.

For the realization of the inventive method in the scope of digital color photography, in which matrixes are employed having varying color-selective optoelectric transducers or sensors, it is thereby proposed to prepare the first and/or second image from more than one partial image that is created by an additional shift of the matrix corresponding to the local distribution of color-selective sensor elements thereof. It is thereby not a necessity to establish the same amount of partial images for the two images mentioned above; there may be one of the images to be easily recorded with the total color information, and thereby with the color information of several partial images, while the other image may be recorded with only the information of one color—per pixel—and whereby the conducted inventive comparison leads to the desired detection of blemished just the same.

In a simple embodiment of the inventive method, the electric image signals of both images are directly compared to each other and they also contain the position information, of course, and sensor elements are identified containing impurities (defects) whereby the output signals of said sensor elements provide a comparison result in the comparison-result image indicating a match in at least a predetermined measure. Since in the above-mentioned mechanical matrix shift, sensor elements containing blemishes are shifted along as well and the mentioned direct comparison provides signal identity at sensor positions containing blemishes—ideally, corresponding zero signals at formation of a variation—whereby disappearing comparison-result signals cannot occur based on shift tolerances, for example, and thereby there is preset the criteria determining the measure of a match, for instance a threshold value, which has to be undercut for identification of an impurity.

In the further development of the present invention, it is basically acknowledged relative to the photography method of the type mentioned in the beginning that a mechanical matrix shift leads to the above-mentioned image behavior, whereas a shift by calculation of an electronically recorded image leads to different behavior. While during a mechanical matrix shift, the blemish-containing image sensor shifts relative to the image of the imaging beam, as it was described, there is no such shift in a shift by calculation of an image. As it will be shown, this generally exploitable inventive knowledge may be combined with the ideal mentioned at the beginning whereby the first and/or second electronically stored image is shifted by calculation—modified is the position information assigned to the electrical image signals and to the respective transducer results on the sensors. Thus, an electronic phantom image is created of the second and/or first image. However, should the first image be shifted through calculation by the inverse mechanical shift process, then a phantom image of the second image is created and the same is true in reverse.

Comparison is now taken between the phantom image and the respective non-phantom image: Should a phantom image be created from the first image, then comparison occurs preferably on the first image and its phantom image, and analogously for the second image. If necessary, there could be phantom images created easily from both images and the detection quality may be increased through double comparison.

Thereby, the detection of impurities has been performed now. In an additional preferred embodiment of the inventive method, there is exploited the fact that the defect-free image information for the impurity is already present in the already existing images.

For the creation of the recorded mage—the definitive image—there are preferably electric signals substituted at the first, second, or the phantom image at positions in which comparison-result signals lie under a preset threshold value relative to the comparison-result image. Thereby there is also the problem eliminated whereby in uniform scenes, uniform scene sections overlap the original images even after a mechanical shift by \overline{S} and which could be interpreted as blemish areas.

Furthermore, it will be possible—as it will be described later—to conclude that impurities on the sensor matrix are (coming) not only from the comparison-result image but also from displaced image areas in the imaging beam.

A digital camera, according to the invention, distinguishes itself further according to the characteristics of claim 10 or according to the one of claim 14 and the preferred embodiments according to claim 11 through 13. The invention is subsequently explained accompanied by drawings, for example. These explanations open for the practitioner various realization possibilities of the present invention. The drawings show, for example, the following:

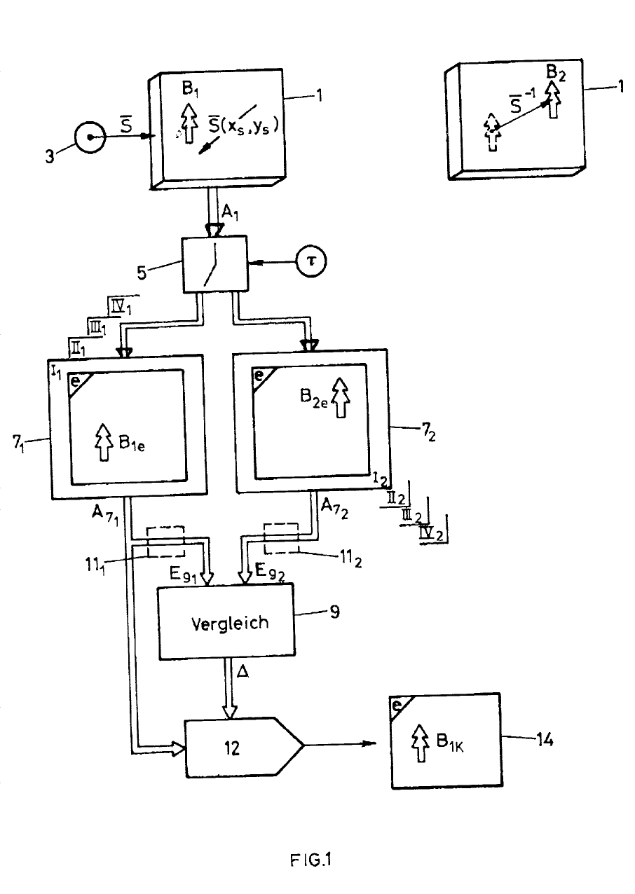

FIG. 1 shows with the aid of a signal flow/functional block diagram the inventive method or a digital camera, according to the invention, wherein the basic principle is realized being the basis for the invention.

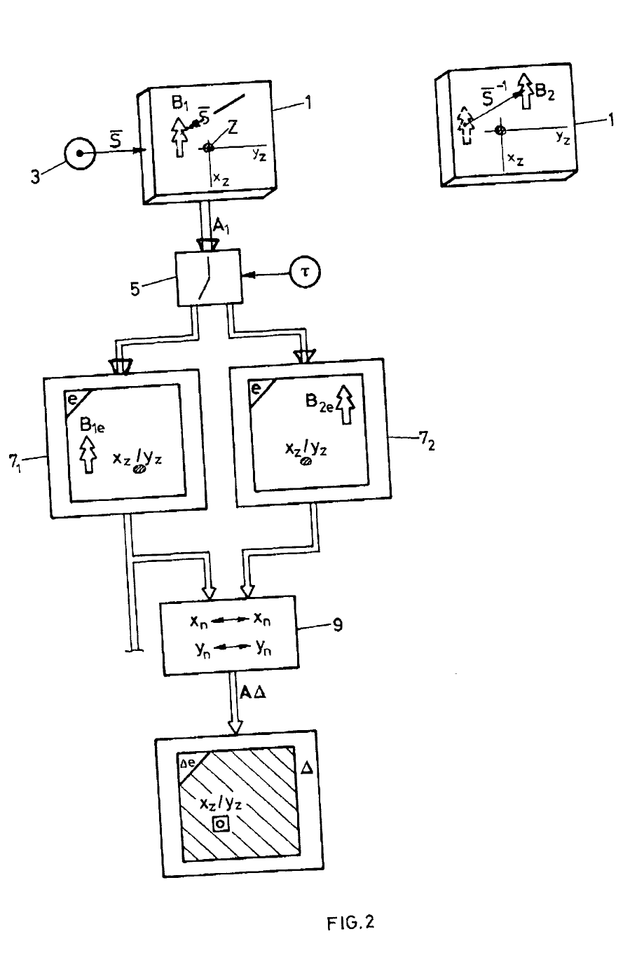

FIG. 2 shows in an illustration, analogous to the one in FIG. 1, a first embodiment of the camera or the method according to the invention.

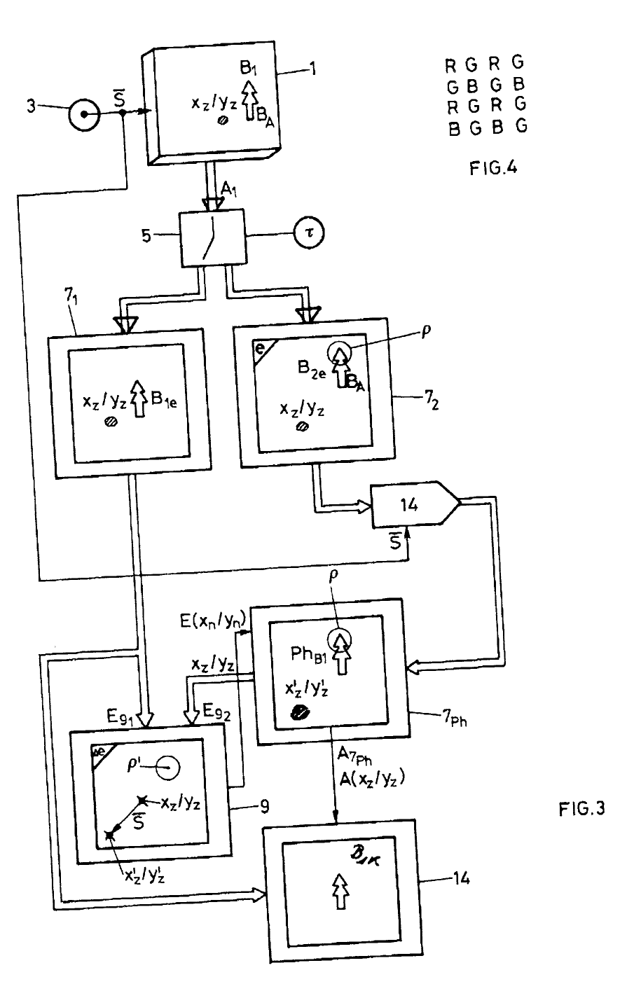

FIG. 3 shows in an illustration, analogous to the ones in FIG. 1 and FIG. 2, the inventive method or a digital camera according to the invention in a preferred embodiment.

FIG. 4 shows an illustration of a Bayer pattern as an example for the pattern of color-selective sensors on a sensor matrix for digital color photography.

### DETAILED DESCRIPTION

FIG. 1 shows with the aid of a signal flow/functional block diagram in a simple manner the basic principle or the method, which is the basis for the digital camera according to the invention.

A matrix 1 of optoelectric sensors, as for instance a CCD matrix, is guided so it may be shifted precisely in the camera relative to the imaging beam (not illustrated) and whereby said matrix is operationally connected to a shift drive 3. It is referred to WO 01/00001 and to the same applicant in reference to a preferably inserted precision guide with a drive of a matrix 1 of this kind in a digital camera, which is to be the integrated description portion of the present invention in this regard.

Image B₁ is reproduced on the matrix 1 by means of the imaging beam of the camera (not illustrated). The electric output signals of the matrix sensor elements at output A₁ are forwarded to a multiplexing unit via a time-controlled switching unit 5.

Matrix 1 is shifted by a preset shift vector \overline{S}(xₛ, yₛ). The image B₂ appears thereby to be reproduced on the matrix 1 being shifted by the direction-inverted vector \overline{S⁻¹}, as illustrated on the right in FIG. 1.

With the aid of the time (-controlled) multiplexing unit 5, the image B₁ₑ optoelectrically transduced on the matrix 1 is stored in a memory unit 7₁ and in the same manner, after the performed shift \overline{S} of matrix 1, so is the image B₂ₑ stored in a memory unit 7₂. The stored images are formed by the signals corresponding to the sensor output signals and the position information of each sensor on the matrix 1. Both signals portions, the signals from optoelectric transducing and from the position information, are mutually identified in the following as output signals of the sensors and thereby also the matrix 1. The electronically stored images B₁ₑ and B₂ₑ are subsequently compared in a comparison unit 9. In FIG. 1 there are the sensor output signals and the position signals corresponding to the respective electronic images B₁ₑ, B₂ₑ directly forwarded to the comparison unit 9. However, as it will be described later, a processing unit 11₁ or 11₂ (illustrated in FIG. 1 with dotted lines) is interconnected to the comparison unit 9 and to one and/or both of the memory units 7₁ or 7₂ so that the respective output A₇₁ or A₇₂ is operationally connected to the corresponding inputs E₉₂ or E₉₁, but not necessary directly.

Output signals of sensors or sensor groups are compared (possibly prepared) with one another in the comparison unit 9 according to a preset algorithm.

With the aid of the comparison result Δ at the output of the comparison unit 9, which corresponds to a matrix of comparison-result signals, the firstly recorded image B₁ₑ is preferably revised. This is performed on an image-processing computing unit 12. It results in the corresponding prepared and corrected electronic image B₁ₖ in a memory unit 14.

With the aid of FIG. 2, which is based on the illustration in FIG. 1, there will now be described a highly preferred embodiment of the inventive method or a digital camera according to the invention, with the goal to recognize impurities which are coupled to the matrix 1, as for instance dust particles on the matrix, scratches on a matrix coating etc.

Say, there is an impurity Z at the location x_{z}, y_{z} on the sensor matrix 1 in form of a dust particle, for example, and should the matrix 1 be shifted by a shift vector \overline{S}, as described in FIG. 1, then the portion in the image B₁ effected by the imaging beam moves on the matrix corresponding to the direction-inverted vector \overline{S}⁻¹. The position coordinates of the impurity Z on the matrix 1 remain the same after the shift of the matrix 1, which means, the image is displaced together with the matrix 1 in contrast to the image from the imaging beam.

The same group of sensors will thereby also pick up the mentioned impurity Z through optoelectric transducing after the shift \overline{S}. The corresponding electronic images B₁ₑ and B₂ₑ are the result in the memory units 7₁ and 7₂.

Should now the respective sensor output signals representing the electronically stored image be compared with one another, particularly the output signal of sensors of the same position coordinates xₙ, yₙ, then there appears—as a comparison-result signal matrix Δ at the out put A_{Δ} of the comparison unit 9—a signal matrix or an electronic “image” on which signal differences disappear at the sensor position biased by the impurity Z or whereby said signal differences fall at least under the preset threshold value. This occurs because the impurity Z on both electronic images B₁, B₁ₑ and B₂, B₂ₑ impair equally the same sensor or position groups.

The basis is established thereby to transmit the information, according to FIG. 1, to the repeatedly reproduced computing unit 12 in FIG. 2, whereby the sensors or pixels influenced by impurities lie in the matrix 1. From that, the computing unit may substitute the impurity-containing output signals, for example, by signal interpolation of output signals of neighboring sensors.

Based on the explanation of FIG. 2, there is an especially preferred embodiment of the present invention illustrated in FIG. 3 whereby the output signals of sensors or pixels containing blemishes or impurities are substituted with signals corresponding to the undisturbed image of the imaging beam and whereby it is further made possible to recognize moving image positions in the imaging beam path and to take these into consideration or to revise them in the computing unit 12 according to FIG. 1.

As already explained with the aid of FIG. 1 and FIG. 2, the images B₁ₑ and B₂ₑ are stored in the assigned memory units 7₁ and 7₂.

The shift vector \overline{S} is now known and according to it, the matrix 1 was shifted for the establishment of image B₂ₑ. There is a phantom image Ph_{B1} established by computation preferably from one of the two stored images B₁ₑ or B₂ₑ as shown in FIG. 3, but preferably from image B₂ₑ. The output memory unit 7₂ is hereby operationally connected to a computing unit 14 and the shift vector information \overline{S} is forwarded thereto, as schematically shown in FIG. 3. The computing unit 14 rearranges anew the sensor output signals shifted by the shift vector \overline{S} and stored in the memory unit 7₂ corresponding to the image B₂ₑ in such a manner that an image is created as a phantom image Ph_{B1} and which is stored in a memory unit 7_{Ph}, which in turn corresponds actually with the image B₁ₑ shifted by \overline{S} but with the difference that the position coordinates of the impurity-impaired sensors or pixels are now

x′_{z}=x_{z}+xₛ

y′_{z}=y_{z}+yₛ

The “impurity” of image B₂ₑ is shifted along as well by \overline{S}. The image Ph_{B1} is thereby the phantom of image B₁ or B₁ₑ. However, on the phantom image there is the impurity shifted by \overline{S} relative to the one in image B₁ or B₁ₑ.

Now occurs the comparison at the comparison unit 9 between the image stored in the memory unit 7 and the electronic image stored in the phantom image memory 7_{Ph} in analogy to FIG. 1 after a preparation 11₂ according to FIG. 3 in the computing unit 14.

The comparison signal matrix formed thereto has only non-disappearing signal values or signal values that lie above the preset threshold value wherever the image B₁ₑ deviates from the phantom image Ph_{B1}, which means, following the illustration in FIG. 3, they lay apart by \overline{S} at the location x_{z}/y_{z} as well as on the location x′_{z}/y′_{z}. Since the shift vector S is known, there is also known the memory unit 9 on the comparison signal matrix Δ which signals originate from impurities on the ones of the two compared images.

However, now it is essential to recognize that information exists of how the undisturbed imaging information appears at the location x_{z}/y_{z} of image B₁ or B₁ₑ. If one considers, however, that at the transfer point from image B₁ or B₁ₑ to B₂ or B₂ₑ, the image present in the imaging beam path (schematically illustrated by B_{A}) has been shifted on the sensor matrix 1 relative to the image of the impurity Z, then it can be seen that the signal in the phantom image Ph_{B1} corresponds to the imaging signal according to the position x_{z}/y_{z}, which means, the defect-free imaging beam reproduction. The signal corresponding to the sensors or pixels with the positions x_{z}/y_{z} are selected from the phantom image memory 7_{Ph} and are read as signal A(x_{z}/y_{z}) at the output A_{7Ph}. The signal A(x_{z}/y_{z}) is placed on the location of the image B₁ or B₂ having the position coordinate x_{z}/y_{z} by means of a computing unit 12 (no longer shown here). The information relative x_{z} and y_{z} is thereby determined from the comparison signal matrix in the comparison unit 9. A defect-free image B_{1K} is thereby established according to B₁ in the image memory unit 14 in FIG. 1 (shown schematically in FIG. 3).

It also completely possible to determine the position values x′_{z} and y′_{z} from the signals on the comparison unit 9 and thereby read the corresponding defect-free signal value from the image B₁ₑ in the memory unit 7₁, and to put said defect-free signal value into the phantom image in place of the signals corresponding to the position values x′_{z}/y′_{z} and thereby to correct the phantom image in the phantom memory 7_{Ph}.

Just the same, it is naturally possible not to shift the image B₂ₑ back through calculation by the shift vector \overline{S}, but to shift by calculation the image B₁ₑ in the memory unit 7₁ by the shift vector \overline{S}⁻¹ or to shift both images B₁ₑ and B₂ₑ practically over the cross, and then proceed analogous to the explanation shown above.

Essential is thereby the knowledge that in a mechanical shift of the sensor matrix 1, impurities Z remain stationary on the matrix while the impurity-image information is shifted together with the imaging-beam image information in a shift via calculation.

The process makes yet further interpretations possible, particularly as it was explained with the aid of FIG. 3. This is to be explained further in the following based on FIG. 3. Should an image B₁ or an area of the imaging-beam-path image B_{A} have moved between the recording of B₁ₑ in the memory unit 7₁ and after the shift \overline{S} of the recording of B₂ₑ in the memory unit 7₂, then this results in a “co-shifted” deviation on the image B₂ₑ relative to image B₁ₑ, as schematically illustrated in FIG. 3 with ρ′. This change p is shifted back during the establishment of the phantom image Ph_{B1} and leads to a sensor area corresponding to a signal area ρ′ on the comparison-signal matrix in the comparison unit 9, whereby the comparison result does not disappear on said sensor area. This is occurring based on the comparison of the phantom image Ph_{B1} against the change ρ′ and against the electronic image B₁ₑ in the memory unit 7₁.

In contrast to the non-defect related, disappearing signals in the comparison-signal matrix Δ in the comparison unit 9, movement-related non-disappearing signals do not lead to double signals. This can be observed without problems by the fact that during the comparison of B₁ₑ and Ph_{B1}, non-disappearing signal values occur in the differential signal matrix as well as on the location x_{z}/y_{z} and also at location x′_{z}/y′_{z}, while during the comparison of the signals related to the imaging beam, only non-disappearing signal values appear in the area ρ′.

By interpretation of the single occurrence of non-disappearing signal values on the comparison signal matrix in the comparison unit and the memory unit 9, and by interpretation of the double occurrence of defect-related, non-disappearing signal values—shifted by \overline{S}—it will be possible to conduct the preparation of the image selectivity under consideration of movement, on one hand, and of defects on the other hand.

The current simplified observations, which the principle of the present invention should show, rest on one side on a “black/white” digital photography technology in which all matrix sensors of equal brightness values are transduced into electric signals, and it is not aspired to established digital color photography.

In practice, the employment of sensors or pixels which record all equally the color information is not (yet) possible. It is known that in sensor matrixes for digital photography there are patterns of sensors provided whereby each records one of the primary colors red, green or blue, for example. Known is thereby the so-called Bayer pattern, which has color grids of the sensor selectivity shown in FIG. 4.

Should there be made one single shot or recording with such a matrix, then one refers to it as a one-shot photograph. This is especially suited to taking a shot of moving objects. The respectively missing color information on the individual sensor has to interpolated from the sensors that surround a viewing sensor.

For photographs of the highest quality there is employed the so-called four-shot method, for example, during the employment of the mentioned Bayer pattern. With this pattern, the matrix is horizontally shifted, respectively, by one sensor grid after one shot, image recording is conducted, then the matrix is shifted vertical by one sensor grid relative to the original position—an additional shot is recorded and finally horizontally and vertically shifted by one diagonal sensor grid—and again an image is recorded. There is made available thereby for each image pixel the color information of the red channel, the blue channel, and twice of the green channel.

The shift occurs thereby preferably according to the arrangement described in WO 01/00001 by its applicant and to the principle described therein.

Should the present inventive method be executed on a matrix of the type described hereby with the aid of FIG. 1 through FIG. 3, as on a Bayer pattern matrix, for example, then the principle based on the present invention may be realized whereby a shift \overline{S} is performed by more than one grid—strictly speaking, even by one diagonal grid already in a combined horizontal/vertical shift of the matrix. Since each second sensor is a green sensor, as it can be seen in FIG. 4, only two already completed images may be interpolated having a recording shifted diagonally by one diagonal grid based on the information density and they (images) may be compared to one another in terms of the present invention. It may very well be indicated to perform a shift by an even number or by an odd number of grids to realize the method according to the invention. With a shift by an even number of grids, it is ensured that at the same image location there are always present sensors of the same color selectivity.

The four-shot technology with a larger shift \overline{S} favors a shift by an odd number of sensor spaces and which shift is to be combined according to the inventive manner in a process described with the aid of FIG. 1 through FIG. 3: In a shift by one grid there will always lie horizontally or vertically a green-selective sensor beside a red-selective sensor, as seen on the Bayer pattern. The same is also true for five, seven etc. grid shifts. The quality advantage of the four-shot technology is thereby combined with the possibility of the inventive process.

These embodiments show that many combination possibilities are available for the practitioner, which all correspond to the inventive process explained above and which improve thereby, more or less, the speed of exposure or the quality of the photograph. In the employment of the present invention relating to color digital photography with matrixes of sensors of varying color selectivity, as for instance a Bayer pattern, the best results are achieved when four shifted image recording are realized for the image B₁ₑ as well as for the image B₂ₑ, respectively, according to the four-shot method. This is indicated in FIG. 1 at the respective memory unit 7₁ and 7₂.

Subsequently, the described method is executed on the assigned four-shot photographs by following the invention, thus

I₁ with I₂

II₁ with II₂ etc.

By this shooting of eight partial images—four before the shift by the vector \overline{S} and four thereafter—preference is clearly given to the quality of the image compared to the expenditure of time in the recording of the image. As the extreme opposite can be considered the shooting of only two images, as it was described, whereby color interpretation is performed subsequently. Of course, the described process may also be employed in the two-shot and three-shot technology.

As is was indicated, it is made possible with the inventive process to eliminate the impurities which are attached to the matrix. This includes especially faulty (impurity-containing) sensors, sensor nests (pixel nests), faulty pixel rows or pixel columns, scratches as well as dust.

Additionally, it must be affirmed that the inventive shift \overline{S} makes interpretation easier by using an even number of grids. However, odd-numbered shifts may also be employed whereby there occur practically no longer ideally disappearing and non-disappearing signal values, as a view of FIG. 3 clarifies. Threshold values must be employed then to discriminate the varying signal differences as described.

1. A digital photography method whereby a matrix (1) of optoelectric sensor elements is shifted at least once relative to the imaging beam of the camera and whereby there is stored a first image (B₁ₑ) in the position before the shift (\overline{S}) and a second image (B₂ₑ) in the position after the shift, each in the form of electric image signals as a function of the sensor output signals and having the respective sensor position information, characterized in that signals depending on the image signals of both images (B₁ₑ, B₂ₑ) are forwarded to a comparison operation (9) and whereby a comparison-result image (Δ) is in turn produced in the form of electric comparison-result signals together with the position information, whereby the first and/or the second image is modified by means of electric signals of the comparison-result image (Δ) for the creation of a photograph (B_{1K}).

2. A method according to claim 1, whereby the first and/or the second image (B₁ₑ, B₂ₑ) is prepared from more than one partial image (I-IV) created by additional shifts of the matrix (1) corresponding to their local distribution of color-selective sensor elements.

3. A method according to one of the claims 1 or 2, whereby electric image signals of the two images (B₁ₑ, B₂ₑ) are compared with one another, whereby sensor elements are identified as impurity-containing (Z), and whereby output signals provide a comparison result in the comparison-result image (Δ) indicating a match in at least a predetermined measure.

4. A method according to one of the claims 1 or 2, whereby the first image (B₁ₑ) and or the second image (B₂ₑ) is shifted by calculation and whereby the position information assigned to the electric image signals is altered so that at least on electronic phantom image is created as one of the images to make a comparison with.

5. A method according to one of the claims 1, 3, or 4, whereby at least the first or second image (B₂ₑ) is shifted by calculation (14) to the position of the other image (B₁ₑ) and whereby the position information is altered relative to the shift (\overline{S}) between the matrix positions so that at least one phantom image (B_{Ph1}) of the other image (B₁ₑ) is created, and whereby comparison is performed between the phantom image (B_{Ph1}) and the other image (B₁ₑ).

6. A method according to claim 5, whereby for the production of the image (B_{K1}) electric signals are substituted on the first image (B₁ₑ), the second image (B₂ₑ), and the phantom image (B_{Ph1}), which assigned sensor elements have positions (x_{z}, y_{z}; x′_{z}, y′_{z}) at which comparison-result signals lie above a preset threshold value within the comparison-result image (Δ).

7. A method according to claim 6, whereby the substitution is performed by electric signals (A (x_{z}/y_{z})) of one of the other images, actually originating from the sensor elements, which positions correspond to the position information at which the comparison-result signals lie above the preset threshold value within the comparison-result image (Δ).

8. A method according to one of the claims 1 through 7, whereby it is concluded that impurities (Z) on the matrix are (coming) from the comparison-result image (Δ) and/or via the displaced image areas (ρ) in the imaging beam.

9. A method according to the introductory clause of claim 1, whereby one conducts a shift by calculation of at least one of the recorded images aside of the mechanical shift (\overline{S}) of the matrix and whereby one evaluates the different reproduction behaviors during the mechanical matrix shift and the electronic image shift for interpretation of the reproduction.

10. A digital camera having an optical system that forms an imaging beam and having a matrix (1) of optoelectric sensor elements which may be shifted relative to said imaging beam of the camera, characterized in that the electric output (A₁) of the matrix (1) is operationally connected to the inputs of at least two image memory units (7₁, 7₂), whereby their outputs (A₇₁, A₇₂) are operationally connected to the inputs (E₉₁, E₉₂) of a comparison unit (9), and whereby the output of said comparison unit (9) leads in turn to an input of a computing unit (12).

11. A digital camera according to claim 10, wherein the outputs of the image memory units (7₁, 7₂) are operationally connected to the inputs (E₉₁, E₉₂) of the comparison unit (9).

12. A digital camera according to claim 10, wherein said matrix (1) is operationally connected to a controllable drive arrangement (7₂), wherein the output of the one image memory unit (7₂) leads via a computing unit (14) to the input of an additional image memory unit (7_{Ph}) whereby an additional input of said computing unit (14) is operationally connected to a shift receiver on said matrix (1) and/or the drive (3), and whereby the output of said additional image memory unit (7_{Ph}) is operationally connected to the input (E₉₂) of the comparison unit (9).

13. A digital camera according to claim 12, wherein an output of the comparison unit is operationally connected to a read-out selection input (E(xₙ, yₙ)) which output (A_{Ph}) is operationally connected to the input on the computing unit (R).

14. A digital camera according to the introductory clause of claim 10, characterized in that said camera has a computing unit (14) which shifts (B_{Ph}) and electronically stored image (B₂ₑ) by computation and which computing unit compares said shifted image (B_{Ph}) to an image (B₁ₑ) recorded by said matrix (1).
